(19) United States
(12) Patent Application Publication
(10) Pub. No.: US 2011/0125383 A1
(43) Pub. Date: May 26, 2011

(54) METHOD FOR BIODIESEL BLENDING DETECTION BASED ON RELATIVE AIR-TO-FUEL RATIO ESTIMATION

(75) Inventors: Alberto VASSALLO, Torino (IT); Claudio CIARAVINO, Torino (IT); Federico Luigi GUGLIELMONE, Rivoli (IT)

(73) Assignee: GM GLOBAL TECHNOLOGY OPERATIONS, INC., Detroit, MI (US)

(21) Appl. No.: 12/907,536

(22) Filed: Oct. 19, 2010

(30) Foreign Application Priority Data
Oct. 19, 2009 (GB) 0918273.4

(51) Int. Cl. G06F 19/00

(52) U.S. Cl. 701/99

(57) ABSTRACT

A method is provided for biodiesel blending detection in an internal combustion engine that includes, but is not limited to a first evaluation of the relative air-to-fuel ratio (RAFR) by means of a first sensor whose output whose output is representative of the actual RAFR value, in order to use such first evaluation as a reference value, a second evaluation of the relative air-to-fuel ratio (RAFR) performed measuring mass air flow (MAF), injected fuel quantity (Q_{fuel}) and stoichiometric air-to-fuel (A/F)_{ST} ratio of petrodiesel and carrying out said second evaluation by means of the Electronic Control Unit (ECU) of the engine, and determining discrepancies of values obtained from the second evaluation compared with values obtained from the first evaluation.

### CROSS-REFERENCE TO RELATED APPLICATION

This application claims priority to British Patent Application No. 0918273.4, filed Oct. 19, 2009, which is incorporated herein by reference in its entirety.

### TECHNICAL FIELD

The present invention relates to a method for biodiesel blending detection based on a relative air-to-fuel ratio estimation by the electronic control unit (ECU) of the vehicle.

### BACKGROUND

Biodiesel can be used in pure form or may be blended with petroleum diesel at any concentration in modern diesel engines of the last generation. It may be foreseen that use of biodiesel will increase in the future especially due to the advantages of such type of fuel. In particular using biodiesel may have the effect of a particulate reduction up to 80%. Furthermore, biodiesel gives the possibility of recalibrating the Soot-NOx trade-off in order to eliminate increase of NOx. Also it gives the possibility of reducing the regeneration frequency of the antiparticulate filter.

However, the use of biodiesel is not without problems; for example with biodiesel fuel, cold start of the motor may be more difficult, especially at low temperatures, with respect to conventional petrodiesel. A further problem is given by increased oil dilution due to the inferior evaporability of biodiesel. Moreover use of biodiesel may have the effect of reducing the power of the motor by 7-10%. Furthermore use of biodiesel may lead to an increase of nitrogen oxides emission up to 60%.

In view of the foregoing, at least one object of the present invention is to enable the detection of biodiesel in the vehicle tank in order to provide an estimate of the percentage volume of biodiesel as accurate as possible. At least another object is to provide this estimate without using dedicated sensors and using only existing engine sensors and data already available to the ECU. At least yet another object of the present invention is to meet these goals by means of a rational and inexpensive solution. In addition, other objects, desirable features, and characteristics will become apparent from the subsequent summary and detailed description, and the appended claims, taken in conjunction with the accompanying drawings and this background.

### SUMMARY

These objects are achieved by a method, by an engine, by a computer program and computer program product, and by an electromagnetic signal.

The method for biodiesel blending detection in a internal combustion engine comprises a first evaluation of the relative air-to-fuel ratio (RAFR) by means of at least a first sensor whose output is representative of the actual RAFR value, in order to use such first evaluation as a reference value, a second evaluation of the relative air-to-fuel ratio (RAFR) performed by measuring mass air flow (MAF), injected fuel quantity (Q_{fuel}) and stoichiometric air-to-fuel (A/F)_{ST} ratio of petrodiesel and carrying out said second evaluation by means of the Electronic Control Unit (ECU) of said engine, and determining a discrepancy in the values obtained from the first and the second evaluation. By this method biodiesel in the fuel can be detected with no extra components using the information already available, and thus without extra costs. Preferably the method comprises the further step of using a pre-calculated correlation set of values between said discrepancies of values and the biodiesel percentage with respect to petrodiesel in order to determine a value of biodiesel blending. The invention is therefore based on the monitoring and comparison of relative air-to-fuel ratio (RAFR) evaluated in two different ways.

The first evaluation is based on a direct measurement of the relative air-to-fuel ratio (RAFR), preferably using the standard oxygen sensor (lambda sensor) placed at the engine exhaust. Such evaluation is not sensitive to the actual biodiesel blending in the vehicle tank and may be used as a reference. The second evaluation estimates relative air-to-fuel ratio (RAFR) from measurements of airflow, of injected fuel quantity and of stoichiometric air-to-fuel ratio of petrodiesel, all of which is information already available to the ECU of the vehicle. Since stoichiometric (A/F)_{ST} ratio is sensitive to biodiesel blending, the RAFR calculated according to this parameter shows increasing discrepancy from the correct value as a function of the increase of the biodiesel percentage with respect to petrodiesel, giving a measure of biodiesel blending. Therefore, by comparing the direct RAFR measurement from lambda sensor with the second RAFR estimation obtained using the ECU of the vehicle, it is possible to determine biodiesel fuelling and blending ratio.

The steps of the method can be repeated continuously in order to achieve a continuous monitoring of the biodiesel percentage.

The method according to the invention can be realized in the form of a computer program comprising a program-code to carry out all the steps of the method and in the form of a computer program product comprising means for executing the computer program. The computer program product comprises, according to a preferred embodiment, a control apparatus for an IC engine, for example the ECU of the engine, in which the program is stored so that the control apparatus performs according to the method. In this case, when the control apparatus executes the computer program, the steps of the method are carried out.

The computer program can be transmitted by means of an electromagnetic signal, said signal being modulated to carry a sequence of data bits which represent a computer program to carry out all steps of the method of the invention.

The invention further provides an internal combustion engine specially arranged for carrying out the detection method.

Further objects, features and advantages of the present invention will be apparent from the detailed description of preferred embodiments that follows, when considered together with the accompanying drawing.

### BRIEF DESCRIPTION OF THE DRAWINGS

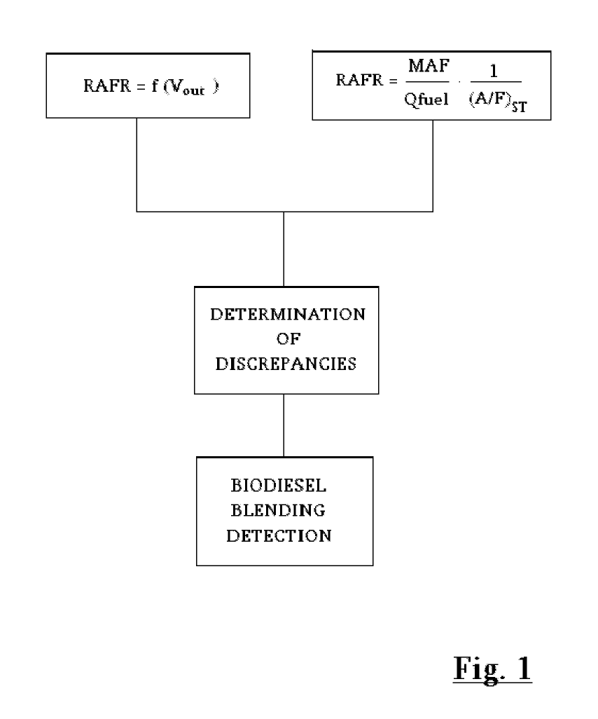

The present invention will hereinafter be described in conjunction with the following drawing FIG. 1, which is a schematic representation of the steps of the method of the invention.

### DETAILED DESCRIPTION

The following detailed description is merely exemplary in nature and is not intended to limit the invention or the application and uses of the invention. Furthermore, there is no intention to be bound by any theory presented in the preceding background of the invention or the following detailed description.

A relative air-to-fuel ratio (RAFR) is evaluated in two alternate ways; the first evaluation is performed directly by-means of lambda sensor output voltage, through sensor output curve:

RAFR=f(Vₒᵤₜ) (1)

Equation (1) is largely independent on fuel specifications and therefore it is able to detect the stoichiometry of the reaction under both petrodiesel and biodiesel fuelling or blends thereof: its output could be considered the true reference RAFR of the reaction.

The second way to evaluate RAFR is performed combining information from trapped air mass, measured for example by a hot-wire sensor HFM, and ECU-estimated fuel injected quantity, based on injector mapping corrected by SW functionalities, according to the following equation:

$$RAFR = \frac{MAF}{Qfuel} \cdot \frac{1}{{( A / F )}_{ST}} \qquad ( 2 )$$

Equation (2) on the contrary is correctly evaluated only if any fuel-induced variations of ECU-estimated Q_{fuel} and of (A/F)_{ST} are accounted for. The parameters of equation (2) are evaluated preferentially considering data available to the ECU for the whole engine. Therefore any variations on those quantities that are not considered would produce a discrepancy between true RAFR of equation (1) and the approximated one of equation (2). If equation (2) is evaluated using both Q_{fuel} and (A/F)_{ST} corresponding to petrodiesel while the engine is actually fuelled with Biodiesel or blends thereof, any discrepancies thereof can thus be considered a measure of biodiesel blending ratio.

The following Table 1 derived from the literature summarizes the differences between the relevant parameters of petrodiesel and biodiesel:

TABLE 1

| Properties | Diesel | Biodiesel |
|---|---|---|
| Carbon content C [w %] | 86.2 | 76.7 |
| Hydrogen content H [w %] | 13.3 | 12.0 |
| Oxygen content O [w %] | — | 11.3 |
| Sulfur content S [w %] | 0.034 | 0.001 |
| (EN ISO 14596-98) | | |
| Stoichiometric ratio (A/F)_{ST} | 14.54 | 12.44 |
| Net heating value, LHV [kJ/kg] | 42925 | 37480 |
| (ASTM D 240-00) | | |
| Density at 15° C., [kg/m³] | 834 | 884 |
| Viscosity at 40° C., [mm²/s] | 2.525 | 4.438 |
| LVH/(A/F)_{ST} [kJ/kg] | 2951 | 3012 |

Tests performed in-house provided stoichiometric (A/F)_{ST} values of: for SME biodiesel (B100): 12.45; for RME biodiesel (B100): 12.29. Therefore (A/F)_{ST} drifts 15% from pure petrodiesel to pure biodiesel, almost independently of biodiesel feedstock. In addition, Q_{fuel} variation due to biodiesel fuelling in such tests showed almost no deterministic influence.

The following Table 2 illustrates variations in the statistic range from engine working-point to working point:

TABLE 2

| | | | | Reference | | Reference diesel | | Reference diesel | | Reference diesel | |
|---|---|---|---|---|---|---|---|---|---|---|---|
| | | | | diesel fuel | | fuel + GTL | | fuel + RME | | fuel + SME | |
| | | | | [ρ = 0.84 kg/l] | | [ρ = 0.81 kg/l] | | [ρ = 0.86 kg/l] | | [ρ = 0.89 kg/l] | |
| | Pᵢₙⱼ | Inj. time | Q_{totGM} | Pilot | Q_{totIM} | Pilot | Q_{totIM} | Pilot | Q_{totIM} | Pilot | Q_{totIM} |
| rpm | Mpa | [μs] | mg/str | mg/str | Mg/str | [mg/str] | [mg/str] | [mg/str] | [mg/str] | [mg/str] | [mg/str] |
| 1500 × 2 | 50 | 260_990_600 | 9.33 | 0.87 | 9.19 | 1.00 | 10.08 | 0.75 | 9.11 | 0.77 | 8.70 |
| | | | | | | [+14.9%] | [+9.7%] | [−13.8%] | [−0.9%] | [−11.5%] | [−5.3%] |
| 2000 × 5 | 97 | 210_1390_560 | 16.83 | 0.78 | 16.81 | 0.91 | 17.76 | 0.82 | 17.56 | 0.83 | 17.04 |
| | | | | | | [+16.7%] | [+5.6%] | [+5.1%] | [+4.5%] | [+6.4%] | [+1.4%] |
| 2000 full | 123 | 200_1400_980 | 60.17 | 0.80 | 61.48 | 1.02 | 58.84 | 0.98 | 61.72 | 0.98 | 60.55 |
| | | | | | | [+27.5%] | [−4.3%] | [+22.5%] | [+0.4%] | [+22.5%] | [−1.5%] |
| 2500 × 8 | 115 | 200_1400_630 | 24.73 | 0.87 | 24.92 | 1.03 | 26.34 | 0.80 | 27.02 | 0.87 | 25.82 |
| | | | | | | [+18.4%] | [+5.7%] | [−8.0%] | [+8.4%] | [±0.0%] | [+3.6%] |

Considering in particular the values of Q_{totIM} for the RME or for the SME columns in Table 2 it may be seen that the variations of Q_{fuel} measured are lower than the statistical dispersion due to injection system itself. Therefore biodiesel blending basically impacts only upon (A/F)_{ST}.

In conclusion, if equation (2) is evaluated considering the stoichiometric air-to-fuel ratio (A/F)_{ST} of petrodiesel, the following discrepancies with the actual RAFR measured by the lambda sensor would arise as function of biodiesel blending as expressed in Table 3, where B0 to B100 indicate corresponding percentages of biodiesel with respect to petrodiesel from 0% to 100%:

TABLE 3

| | |
|---|---|
| A/F | Delta RAFR wrt B0 |

| | RME | SME | RME | SME |
|---|---|---|---|---|
| B0 | 14.51 | 14.51 | 0.0% | 0.0% |
| B10 | 14.29 | 14.30 | −1.5% | −1.4% |
| B20 | 14.07 | 14.10 | −3.1% | −2.8% |
| B30 | 13.84 | 13.89 | −4.6% | −4.3% |
| B40 | 13.62 | 13.69 | −6.1% | −5.7% |
| B50 | 13.40 | 13.48 | −7.6% | −7.1% |
| B60 | 13.18 | 13.27 | −9.2% | −8.5% |
| B70 | 12.96 | 13.07 | −10.7% | −9.9% |
| B80 | 12.73 | 12.86 | −12.2% | −11.4% |
| B90 | 12.51 | 12.66 | −13.8% | −12.8% |
| B100 | 12.29 | 12.45 | −15.3% | −14.2% |

Therefore a correspondence can be made between a measured discrepancy Delta RAFR with respect to petrodiesel fuelling and a corresponding biodiesel percentage that expresses the actual biodiesel blending measured. Also interpolation between values of Table 3 may be performed for increased accuracy since the above correspondence is substantially linear.

The accuracy on the blending detection depends on the measurement accuracy for equation (2) and equation (1), and defines the threshold for safe blending rate evaluation. Statistical accuracy estimation is employed for determining such a threshold: MAF accuracy is typically about 3%; Q_{fuel} is typically 3% using injector production dispersion and drift corrections; Lambda (RAFR) sensor accuracy is typically 2%. By making a statistical analysis of tolerance of these errors using the formula φ_{TOT}=\sqrt{φ_{MAF}²+φ_{Qfuel}²+φ_{RAFR}²}, a detectability threshold slightly below 5% can be estimated.

Blending detection is more precise at mid-high loads where relative sensor accuracies are the lowest, and does not show sensitivity to EGR rate, provided EGR does not decrease MAF to values so low that hot-wire sensor HFM accuracy becomes critical. Fine-tuning of this strategy and verification of its potentialities will be critical on actual engine hardware, since B30 is already impacting in an appreciable way oil dilution, soot accumulation on DPF, as well as modifying engine-out emissions. Detection of biodiesel blends lower than B30 may be less accurate.

The invention has numerous important advantages. As a general rule, biodiesel blending detection allows optimizing a series of parameters of engine performance and is able to minimize negative issues arising from fuel consumption. In particular, the invention allows for a correction of injection strategies, such as number, phase and period of each injection or such as injection pressure specific for the biodiesel blend at which the engine is working.

Concerning engine power, the method allows calibration of injection period in order to compensate the decrease of calorific value of biodiesel and maintain the power level at the same value of the petrodiesel reference. The optimization of the injection strategy is also useful in order to optimize cold start of the engine by means of calibration, among other parameters, of injection pressure and of the glow plug heating.

From an ecological point of view the calibration of the injection strategy allows to maintain NOx emission level to the homologation value corresponding to the petrodiesel reference. At the same time control of air/EGR is improved specifically as a function of the biodiesel blend.

Since biodiesel requires shorter oil drain intervals, as a consequence of the determinations of the method oil life monitoring is customized to actual engine fuelling. Moreover, since biodiesel may enable longer intervals between DPF regeneration events, soot accumulation specific of biodiesel blend can be estimated by statistical models and therefore DPF regeneration events can be adapted to actual engine fuelling.

Last, but not least, no additional sensors are needed to perform the method of the invention and therefore there is no related increase of costs for current diesel engine configuration.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment, it being understood that various changes may be made in the function and arrangement of elements described in an exemplary embodiment without departing from the scope of the invention as set forth in the appended claims and their legal equivalents.

What is claimed is:

1. A method for biodiesel blending detection in an internal combustion engine comprising the steps of:
performing a first evaluation of a relative air-to-fuel ratio (RAFR) with a first sensor having a first output representative of an actual RAFR value;
performing a second evaluation of the relative air-to-fuel ratio (RAFR) with an electronic control unit of said internal combustion engine, said second evaluation performed by measuring a stoichiometric air-to-fuel (A/F)_{ST} ratio of petrodiesel, an mass air flow (MAF), and a injected fuel quantity (Q_{fuel});
determining a discrepancy between values obtained from the first evaluation and the second evaluation.

2. The method according to claim 1, further comprising the step of using a pre-calculated correlation set of values between said discrepancy and a biodiesel percentage with respect to petrodiesel in order to determine a value of biodiesel blending.

3. The method according to claim 1, wherein said first sensor is a lambda sensor.

4. The method according to claim 1, wherein said second evaluation of the relative air-to-fuel ratio (RAFR) is performed in accordance with:
$$RAFR = \frac{MAF}{Qfuel} \cdot \frac{1}{{( A / F )}_{ST}}$$
where MAF is the mass air flow, Q_{fuel} is the injected fuel quantity, and (A/F)_{ST} is the stoichiometric air-to-fuel ratio for petrodiesel.

5. The method according to claim 4, wherein determining the value of biodiesel blending, a correspondence between an actual stoichiometric air-to-fuel ratio for biodiesel blend and the RAFR evaluated according to said second evaluation is established.

6. The method according to claim 5, wherein said correspondence is substantially linear in order to allow an interpolation of values.

7. The method according to claim 1, wherein the first evaluation and the second evaluation are repeated in order to achieve a monitoring of a biodiesel percentage.

8. The method according to claim 1, wherein the first evaluation and the second evaluation of RAFR are performed with a consideration of data available to the electronic control unit for the internal combustion engine.

9. An internal combustion engine, comprising:
a plurality of sensors for measurement of combustion parameters, a first; and
an electronic control unit configured to:
perform a first evaluation of a relative air-to-fuel ratio (RAFR) with a first sensor of the plurality of sensors having a first output representative of an actual RAFR value;
perform a second evaluation of the relative air-to-fuel ratio (RAFR), said second evaluation performed by measuring a stoichiometric air-to-fuel (A/F)_{ST} ratio of petrodiesel, an mass air flow (MAF), and an injected fuel quantity (Q_{fuel});
determine a discrepancy between values obtained from the first evaluation and the second evaluation.

10. The internal combustion engine according to claim 9, said electronic control unit further configured to use a pre-calculated correlation set of values between said discrepancy and a biodiesel percentage with respect to petrodiesel in order to determine a value of biodiesel blending.

11. The internal combustion engine according to claim 9, wherein said first sensor is a lambda sensor.

12. The internal combustion engine according to claim 9, wherein said second evaluation of the relative air-to-fuel ratio (RAFR) is performed in accordance with:
$$RAFR = \frac{MAF}{Qfuel} \cdot \frac{1}{{( A / F )}_{ST}}$$
where MAF is the mass air flow, Q_{fuel} is the injected fuel quantity, and (A/F)_{ST} is the stoichiometric air-to-fuel ratio for petrodiesel.

13. The internal combustion engine according to claim 12, wherein determining the value of biodiesel blending, a correspondence between an actual stoichiometric air-to-fuel ratio for biodiesel blend and the RAFR evaluated according to said second evaluation is established.

14. The internal combustion engine according to claim 13, wherein said correspondence is substantially linear in order to allow an interpolation of values.

15. The internal combustion engine according to claim 9, wherein the first evaluation and the second evaluation are repeated in order to achieve a monitoring of a biodiesel percentage.

16. The internal combustion engine according to claim 9, wherein the first evaluation and the second evaluation of RAFR are performed with a consideration of data available to the electronic control unit for the internal combustion engine.

17. A computer readable medium embodying a computer program product, said computer program product comprising:
a program for biodiesel blending detection in an internal combustion engine, the program configured to:
perform a first evaluation of a relative air-to-fuel ratio (RAFR) with a first sensor having a first output representative of an actual RAFR value;
perform a second evaluation of the relative air-to-fuel ratio (RAFR) with an electronic control unit of said internal combustion engine, said second evaluation performed by measuring a stoichiometric air-to-fuel (A/F)_{ST} ratio of petrodiesel, a mass air flow (MAF), and an injected fuel quantity (Q_{fuel}); and
determine a discrepancy between values obtained from the first evaluation and the second evaluation.

18. The computer readable medium embodying a computer program product according to claim 17, the program further configured to use a pre-calculated correlation set of values between said discrepancy and a biodiesel percentage with respect to petrodiesel in order to determine a value of biodiesel blending.

19. The computer readable medium embodying a computer program product according to claim 17, wherein said first sensor is a lambda sensor.

20. The computer readable medium embodying a computer program product according to claim 17, wherein said second evaluation of the relative air-to-fuel ratio (RAFR) is performed in accordance with:
$$RAFR = \frac{MAF}{Qfuel} \cdot \frac{1}{{( A / F )}_{ST}}$$
where MAF is the mass air flow, Q_{fuel} is the injected fuel quantity, and (A/F)_{ST} is the stoichiometric air-to-fuel ratio for petrodiesel.
